(19) United States
(12) Patent Application Publication
(10) Pub. No.: US 2022/0172458 A1
(43) Pub. Date: Jun. 2, 2022

(54) INDIVIDUAL IDENTIFICATION INFORMATION GENERATION METHOD, INDIVIDUAL IDENTIFICATION INFORMATION GENERATION DEVICE, AND PROGRAM

(71) Applicant: NEC Corporation, Minato-ku, Tokyo (JP)

(72) Inventor: Mitsugu MIURA, Tokyo (JP)

(73) Assignee: NEC Corporation, Minato-ku, Tokyo (JP)

(21) Appl. No.: 17/437,228

(22) PCT Filed: Mar. 6, 2020
(86) PCT No.: PCT/JP2020/009780

§ 371 Date: Sep. 8, 2021

(30) Foreign Application Priority Data
Mar. 18, 2019 (JP) 2019-049864

(51) Int. Cl. G06V 10/77; G06V 10/74; G06T 7/70; G06T 7/00

(52) U.S. Cl. CPC G06V 10/7715; G06V 10/761; G06T 7/0006; G06T 7/0008; G06T 7/70

(57) ABSTRACT

An individual identification information generation device 100 of the present invention includes an extraction unit 121 and a generation unit 122. The extraction unit 121 extracts, on the basis of product information in which manufacturing state information representing a manufacturing state of a product and individual identification information using a surface pattern of the product acquired from a captured image of the product are associated with each other, a relationship between the manufacturing state information and the individual identification information. The generation unit 122 generates, on the basis of the relationship between the manufacturing state information and the individual identification information and of the manufacturing state information of a given product, the individual identification information of the given product.

### TECHNICAL FIELD

The present invention relates to an individual identification information generation method, an individual identification information generation device, and a program.

### BACKGROUND ART

Recently, in a manufacturing premise of the manufacturing industry, manufacturing history such as machining and inspection of each of the products to be manufactured is accumulated and analyzed as big data, which are utilized to improve the quality management and the production efficiency, and also to improve the design and machining accuracy. In particular, quality management of a product is important. It is necessary to identify an individual that is a product itself. That is, by acquiring individual identification information of a product flowing through the manufacturing line, and storing the individual identification information in association with the manufacturing state information, it is possible to acquire the manufacturing history.

Here, for individual identification of a product, the product may be engraved with a mark, given with a manufacturing number or a bar code, or attached with a tag such as a Radio Frequency IDentifier (RFID). However, for products that are produced in a large amount such as screws or rods, in the case of performing individual identification using a mark, a bar code, or an RFID, it is necessary to apply it to each product, which causes a problem of a cost increase. Moreover, for small products such as tablet pharmaceuticals, there is a case where a mark, a bar code, or an RFID cannot be given due to a restriction in the size or product characteristics. Moreover, in the case of a mark, a bar code, or an RFID, a problem that the information given to a product may be easily lost is also caused.

To cope with it, in recent years, an object fingerprint authentication technology for performing individual identification using a fine pattern (object pattern) on a surface of a product has been proposed. Specifically, in the object fingerprint authentication technology, individual identification of a product is performed by acquiring a fine pattern that is naturally generated in the manufacturing process of the product such as a random pattern on a surface of a material, as an image with use of a capturing device such as a camera, and identifying the fine pattern. For example, Patent Literature 1 discloses an example of a technology of performing individual identification using an object fingerprint.

Patent Literature 1: JP 6354589 B

### SUMMARY

However, in the case of performing individual identification using an object fingerprint, it is necessary to capture an image of the product in advance, that is, before shipping the product, for example. Therefore, for a product whose image is not captured, individual identification information such as an object fingerprint is not registered, which causes a problem that such a product cannot be collated later.

In view of the above, an object of the present invention is to solve the aforementioned problem, that is, a problem that in the case of performing collation of a product using individual identification information such as an object fingerprint, a product whose image is not captured cannot be collated.

An individual identification information generation method, according to one aspect of the present invention, is configured to include

on a basis of product information in which manufacturing state information representing a manufacturing state of a product and individual identification information using a surface pattern of the product acquired from a captured image of the product are associated with each other, extracting a relationship between the manufacturing state information and the individual identification information; and

on a basis of the relationship between the manufacturing state information and the individual identification information and of the manufacturing state information of a given product, generating the individual identification information of the given product.

An individual identification information generation device, according to one aspect of the present invention, is configured to include

an extraction unit that, on a basis of product information in which manufacturing state information representing a manufacturing state of a product and individual identification information using a surface pattern of the product acquired from a captured image of the product are associated with each other, extracts a relationship between the manufacturing state information and the individual identification information; and

a generation unit that, on a basis of the relationship between the manufacturing state information and the individual identification information and of the manufacturing state information of a given product, generates the individual identification information of the given product.

A program according to one aspect of the present invention, is configured to cause an information processing device to realize

an extraction unit that, on a basis of product information in which manufacturing state information representing a manufacturing state of a product and individual identification information using a surface pattern of the product acquired from a captured image of the product are associated with each other, extracts a relationship between the manufacturing state information and the individual identification information; and

a generation unit that, on a basis of the relationship between the manufacturing state information and the individual identification information and of the manufacturing state information of a given product, generates the individual identification information of the given product.

With the configurations described above, the present invention enables generation of appropriate individual identification information for a product whose image is not captured, and enables collation of the product.

### BRIEF DESCRIPTION OF DRAWINGS

FIG. 1 is a block diagram illustrating configurations of an object fingerprint determination device and an object fingerprint generation device according to a first exemplary embodiment of the present invention.

FIG. 2 illustrates an example of information processed in the object fingerprint generation device disclosed in FIG. 1.

FIG. 3 illustrates an example of information processed in the object fingerprint generation device disclosed in FIG. 1.

FIG. 4 is a flowchart illustrating an operation of the object fingerprint generation device disclosed in FIG. 1.

FIG. 5 is a block diagram illustrating a hardware configuration of an individual identification information generation device according to a second exemplary embodiment of the present invention.

FIG. 6 is a block diagram illustrating a configuration of the individual identification information generation device according to the second exemplary embodiment of the present invention.

FIG. 7 is a flowchart illustrating an operation of the individual identification information generation device according to the second exemplary embodiment of the present invention.

### EXEMPLARY EMBODIMENTS

### First Exemplary Embodiment

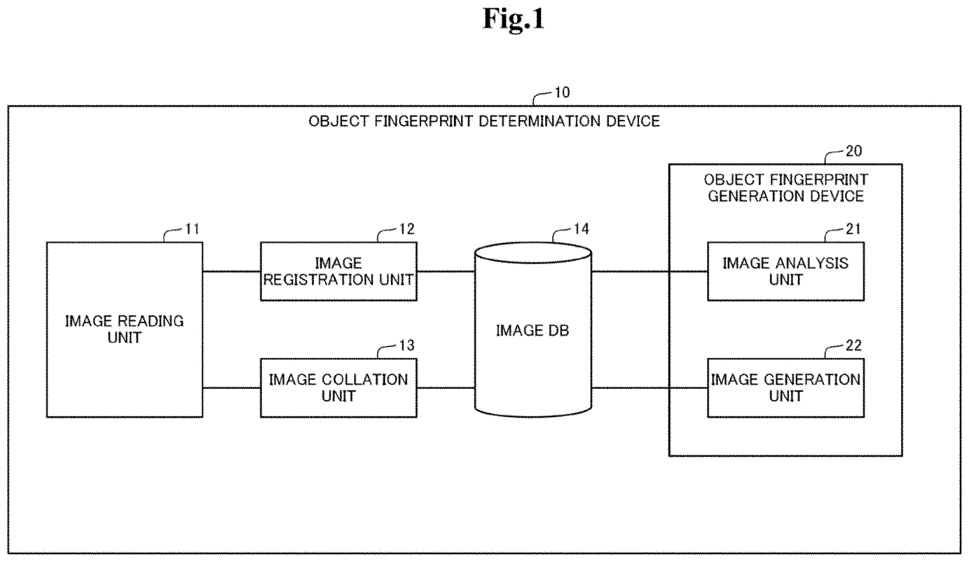

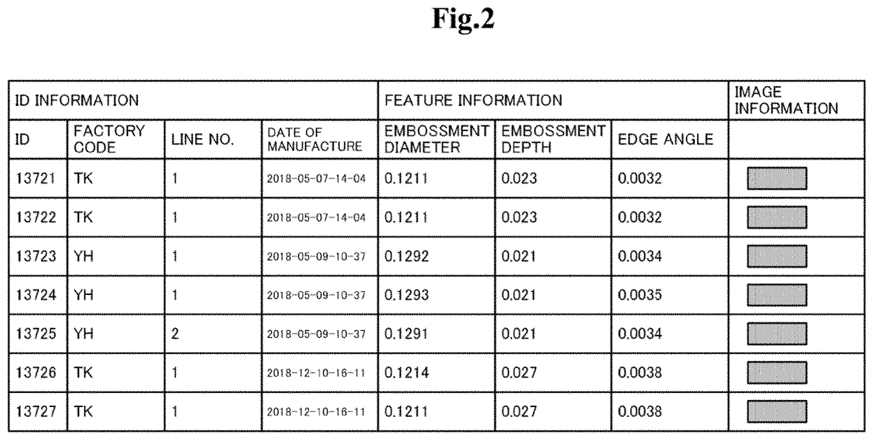

A first exemplary embodiment of the present invention will be described with reference to FIGS. 1 to 4. FIG. 1 is a diagram for explaining configurations of an object fingerprint determination device and an object fingerprint generation device, and FIGS. 2 to 4 are drawings for explaining the processing operation of the object fingerprint generation device.

### Configuration

An object fingerprint determination device 10 of the present embodiment is a device for performing individual identification of a product using an object fingerprint. Specifically, the object fingerprint determination device 10 is configured of one or a plurality of information processing devices each having an arithmetic unit and a storage unit. As illustrated in FIG. 1, the object fingerprint determination device 10 includes an image reading unit 11, an image registration unit 12, and an image collation unit 13 that are constructed by execution of a program by the arithmetic unit. The object fingerprint determination device 10 includes an image database (DB) 14 formed in the storage unit. The object fingerprint determination device 10 also includes an object fingerprint generation device 20 formed of an information processing device constituting the object fingerprint determination device 10. The object fingerprint generation device 20 includes an image analysis unit 21 and an image generation unit 22 that are constructed by execution of a program by the arithmetic unit. Hereinafter, each configuration will be described in detail.

The image reading unit 11 has a function of reading an image from which an object fingerprint of a product is collected. Accordingly, in general, the object fingerprint determination device 10 is connected with an imaging device such as a camera or a scanner, and acquires a captured image of a product that is captured by such an imaging device. Note that the image reading unit 11 reads a surface area of the product that is previously set as a portion from which an object fingerprint of the product is extracted. This means that the image reading unit 11 reads an image of the identical location for all products.

When the image registration unit 12 newly registers a captured image of a product, the image registration unit 12 registers a captured image acquired by the image reading unit 11 in the image DB 14. At that time, the image registration unit 12 may not only register the capture image as it is in the image DB 14, but also extract the feature amount of the product from the captured image and register the feature amount (individual identification information) and information representing the manufacturing state of the product in the image DB 14 in association with each other, in order to improve the searching speed for collation. The information to be registered in the image DB 14 will be described later in detail. Further, the function of extracting the feature amount from a captured image of a product by the image registration unit 12 is a general technique used in the object fingerprint authentication technology, and an example of which will be described later in detail.

The image reading unit 13 is a device that searches the image DB 14 using the feature amount of the captured image acquired by the image reading unit 11 to perform collation of the individual that is a product. The function of performing collation using the feature amount extracted from a captured image of a product by the image collation unit 13 is a general technique used in the object fingerprint authentication technology. An example thereof will be described below in detail.

Here, an object fingerprint authentication technology will be briefly described. In general, industrial products of the same specification are manufactured using manufacturing devices of the same specification so as not to have variations. However, even in mechanical components applied with cutting processing with high accuracy or components manufactured from the same mold, when the surfaces of the products are enlarged using a microscope under a specific illumination condition, pieces of unevenness on the surfaces slightly differ from each other individually, which can be observed as different patterns. Such a fine pattern is of a level unrelated to the performance and the quality of a product and a component, and since each has a unique different feature, the individual difference can be recognized in an image. That is, like a living thing, an industrial product also has a unique fingerprint individually, and it is possible to perform individual identification using such an object fingerprint.

Specifically, when an object fingerprint is extracted from a product, for example, a surface of a product is captured under a specific illumination condition, and from the captured image, a location where a change in the luminance is steep and the position is stably obtained is determined as a feature point. Then, by putting a local luminance pattern around the feature point into data as a feature amount, it is extracted as an object fingerprint of the product. Then, in the case of collating object fingerprints for checking whether or not they are identical products, it is performed by verifying consistency in the geometric arrangement of the feature points. For example, from the object fingerprints to be collated with each other, feature points in which the difference between the feature amounts is the minimum is obtained as a pair, and from the obtained pair groups, only pair groups in which a relative positioning relationship with another feature point does not contradict are extracted. Then, a collation score S=ninlier/Ntotoal of the two images is calculated, where Ntotoal represents the number of extracted feature points, and ninlier represents the number of feature point pairs in which the geometric arrangement is correct. When the collation score is higher than a given threshold, it can be determined that the products from which the collated object fingerprints are extracted are identical. Note that the object fingerprint extraction method and the collation method described above are just examples, and any methods may be used.

In the image DB 14, as “product information”, “image information” that is a captured image of a product to be newly registered is stored in association with “feature information” that is a feature amount serving as an object fingerprint of the product extracted from the captured image and “ID information” (manufacturing state information) representing the manufacturing state of the product. For example, as illustrated in FIG. 2, “product information” has “ID information” representing the manufacturing state of the product consisting of four categories, namely “ID” representing the manufacturing number given for identifying the product, “factory code” for distinguishing the factory where the product is manufactured, “line number” for distinguishing the facility (line) where the product is manufactured, and “date of manufacture” for distinguishing the time (year, month, date) when the product is manufactured. In the example of FIG. 2, “ID” is a manufacturing number that is given in the order of manufacturing in each factory and each line, “factory code” is “TK” when it is manufactured in the Tokyo factory or “YH” when it is manufactured in the Yokohama factory, and the “date of manufacture ” is the year, month, date, and time of the manufacturing. In the present invention, the categories set as “ID information” of the product are not limited to the four categories described above. Any information may be used if it is information representing the manufacturing state of the product.

Further, as illustrated in FIG. 2, “product information” has “feature information” representing the feature amount of the surface pattern of the product including three types, namely “embossment diameter” representing the diameter of an embossment serving as the feature amount of the shape of the embossment on a surface of punch metal that is processed metal used for the product, “embossment depth” representing the depth of the engravement, and “edge angle” representing the angle of the edge of the embossment. However, the “feature information” of the product is not limited to the three types of feature amounts described above. Any information may be used if it is information representing the feature of the surface pattern of the product and serving as a feature amount that is different for each product.

The object fingerprint generation device 20 is a device for generating, for a product whose image is captured, an object fingerprint that is an individual identification information for individually identifying the product. Note that the product whose image is not captured is one in which at least one of the “ID information” (“ID”, “factory code”, “line number”, and “date of manufacture”) that is a manufacturing state of the product has been known. The image analysis unit 21 and the image generation unit 22 provided to the object fingerprint generation device 20 have the functions described below

The image analysis unit 21 (extraction unit) analyzes the “product information” stored in the image DB 14, and extracts a relationship between the “ID information” representing the manufacturing state of the product and the “feature information” of the product. Here, a process of analyzing “product information” by the image analysis unit 21 will be described below in detail.

First, in general, regarding the processing accuracy of a product, there is no problem as a product if it is within the margin of the specification or a datasheet. However, variations occur in the processing practically, which is used as object fingerprints. Further, processing machines for performing processing on objects differ depending on the factories or operation lines. Such a difference affects the object fingerprints. For example, distribution conditions are different, that is, “in the products manufactured in the factory A, errors in the diameter of embossment are distributed near the lower limit of the tolerance”, or “in the products manufactured in the factory B, errors in the edge angle are small”. Moreover, when a component of a processor (cutting blade or the like) is degraded over time, it is possible to obtain information that distribution of errors changes in a time-series manner (or depending on the number of manufactured pieces), and the like.

By using the product information as described above, it is possible to obtain a relationship between “ID information” and “feature information” from the distribution condition of respective data statistics. The relationship between the “ID information” and the “feature information” described above can be grasped by a method that is almost similar to a quality management method using multiple regression analysis or covariance structure analysis, in general. Note that the image analysis unit 21 may extract the relationship between the “ID information” and the “feature information” by machine learning. For example, the relationship between the “ID information” and the “feature information” may be extracted through machine learning in which the “ID information” is used as an input value and the “feature information” is used as teacher data of an output value.

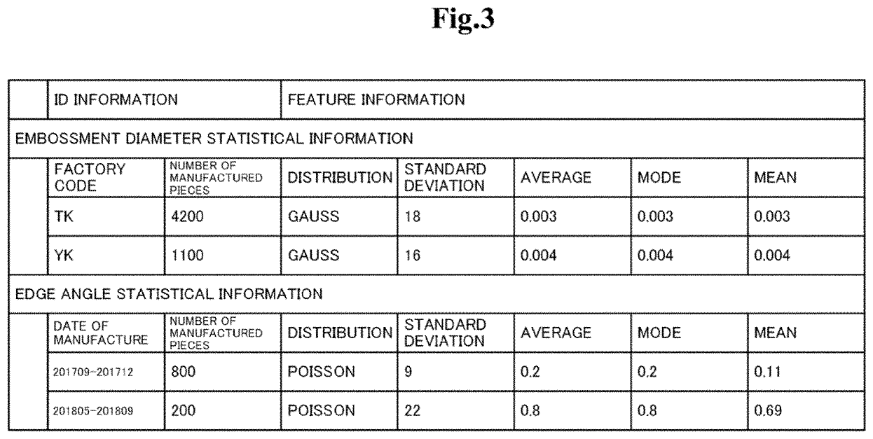

FIG. 3 illustrates an example of extracting a relationship between the “ID information” and the “feature information” from the “product information” by the image analysis unit 21. In the example shown in the upper part of FIG. 3, an attention is paid to the “factory code” in the “ID information”, and a relationship with the distribution of values of “embossment diameter” that is “feature information” is extracted for each “factory code” representing a group for distinguishing products (manufacturing state group). Further, in the example shown in the lower part of FIG. 3, an attention is paid to the “date of manufacture” in the “ID information”, and a relationship with the distribution of values of “edge angle” that is “feature information” is extracted for each “range of date of manufacture” representing a group for distinguishing products (manufacturing state group).

Note that FIG. 3 is an example. The image analysis unit 21 may extract any relationship between the “ID information” and the “feature information”. For example, the image analysis unit 21 may extract the feature of “feature information” such as distribution of “embossment diameter” or distribution of “embossment depth”, for each “line number” or each “given range of ID (manufacturing number).

The image generation unit 22 (generation unit) generates an object fingerprint of a product whose image is not captured, on the basis of the feature of the feature information of each piece of ID information extracted by the image analysis unit 21 as described above. Specifically, the image generation unit 22 first receives “ID information” of a product whose image is not captured and for which an object fingerprint is to be generated. Then, the image generation unit 22 specifies the category to which the received “ID information” belongs and a group in the category, and selects a feature of the feature information corresponding to the specified group of category. Further, the image generation unit 22 generates feature information as a feature amount of the target product, using the selected feature of the feature information. At that time, when the number of selected features of the feature information is plural, it is possible to generate new feature information as a feature amount of the target product by combining the plurality of features of the feature information, or generate new pieces of feature information by changing the combination of features of the feature information.

As an example, when the “factory code” of the “ID information” of a target product is

“TK (Tokyo factory)”, the image generation unit 22 extracts a feature of “feature information” such as “distribution of values of embossment diameter” corresponding thereto, and when the “date of manufacture” is “June, 2018”, the image generation unit 22 extracts a feature of “feature information” such as “distribution of values of edge angle” corresponding to the range of the date of manufacture. Then, the image generation unit 22 generates new “feature information” reflecting the extracted feature of the “feature information” as an object fingerprint, and generates an image from such “feature information”. However, the image generation unit 22 may only generate new “feature information” without actually generating an image.

Further, the image generation unit 22 newly assigns an “ID (manufacturing number)” to the target product, and stores the newly generated “feature information” and “image” in the image DB 14 in association with the “ID information”, as illustrated in FIG. 2. At that time, the image generation unit 22 checks whether or not the object fingerprint configured of the newly generated “feature information” is identical to another object fingerprint having been registered in the image DB 14, and when the newly generated object fingerprint is identical to the existing object fingerprint, deletes the new object fingerprint. Then, when a plurality of object fingerprints are generated for the target product, the other object fingerprints are stored in the image DB 14. In the case where the new object fingerprint generated for the target product is deleted because it is identical to the existing object fingerprint, when another object fingerprint has not been generated for the product, new “feature information” is generated again from the feature of the “feature information” corresponding to the “ID information”, and is used as an object fingerprint of the product.

While an object fingerprint (image) is generated for the product whose image is not captured as described above, as the object fingerprint, a statistically highly-probable image is automatically generated. Therefore, it is not necessarily an object fingerprint (image) corresponding to the newly assigned ID (manufacturing number) exactly. For example, an object fingerprint (image) corresponding to a manufacturing number K or an object fingerprint (image) corresponding to a manufacturing number K+1 cannot be obtained exactly. That is, a tentative ID is assigned to an object fingerprint that is automatically generated. However, an ID with the manufacturing number K or K+1 does not remain actually, and it is in a condition that N pieces of products created in a certain period exists, but it is highly likely that the generated object fingerprint (image) corresponds to any of the N pieces of components. Therefore, no problem arises in operation even if the newly assigned ID is used as a real ID.

### Operation

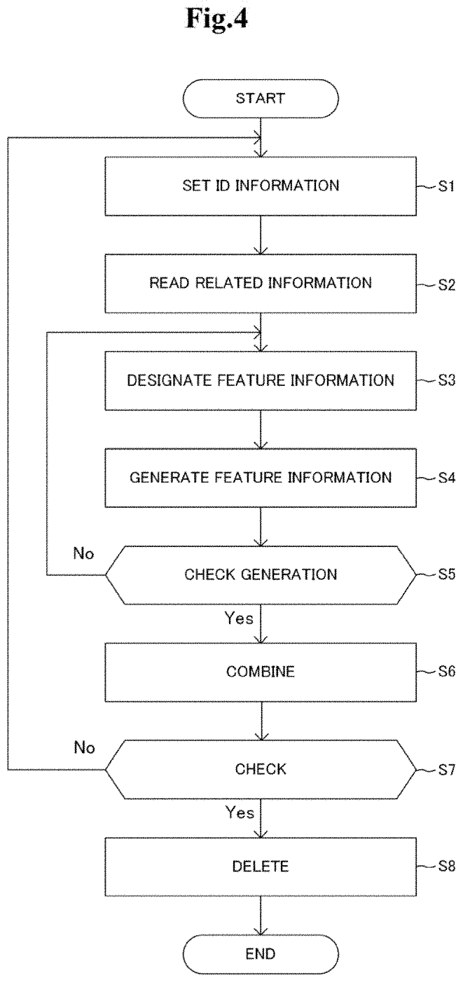

Next, an operation of generating a new object fingerprint by the object fingerprint generation device 20, of the operation of the object fingerprint determination device 10 described above, will be described in particular with reference to the flowchart of FIG. 4.

First, the object fingerprint generation device 20 sets “ID information” (ID, factory code, line No., date of manufacture, and the like) with respect to a target product whose image is not captured (step S1). Then, the object fingerprint generation device 20 reads the relationship between the “ID information” and the “feature information” extracted from the existing “product information” (step S2). It is assumed that the object fingerprint generation device 20 has extracted the relationship between the “ID information” and the “feature information” as illustrated in FIG. 3 in advance, from the existing “product information” as illustrated in FIG. 2.

Then, from the information about the relationship between the “ID information” and the “feature information”, the object fingerprint generation device 20 extracts one type of “feature information” (statistical information) (for example, distribution of values of embossment diameter) (step S3). Then, among them, by using the “feature information” (statistical information) corresponding to the “ID information” of the target product, the object fingerprint generation device 20 generates new “feature information” in the descending order of probability (step S4). For example, new “feature information” is generated through processing such as “generating an actual error from the error distribution of embossment diameter in Tokyo factory”, “reflecting a time-series change as statistical information on the actual error generation”, “applying a processing trace unique to Yokohama factory”, and the like. Note that when generating new “feature information” in accordance with the extracted statistical probability, a plurality of pieces of feature data are generated in the same type. It is also possible to generate and store a plurality of pieces of feature information for one ID.

Then, the object fingerprint generation device 20 newly generates “feature information” for all types (for example, embossment diameter, embossment depth, edge angle, and the like) as described above (Yes at step S5), and generates an object fingerprint by combining these types of “feature information” (step S6). Then, the object fingerprint generation device 20 stores the newly generated object fingerprint in the image DB 14 in association with the “ID information” of the target product.

The object fingerprint generation device 20 checks whether or not a new object fingerprint is generated for every target product as described above (step S7). Then, when the new object fingerprint matches an existing object fingerprint in the image DB 14, the object fingerprint generation device 20 deletes the new object fingerprint (step S8). In that case, for the target product, a new object fingerprint may be generated again as described above.

As described above, in the present invention, by extracting a feature corresponding to the manufacturing state (ID information) of the product from the existing object fingerprint, even for a product whose image is not captured, it is possible to newly generate an object fingerprint using the feature corresponding to the manufacturing state of the product. Thereby, it is possible to generate an object fingerprint appropriately reflecting the feature of a product whose image is not captured, and to perform individual identification by performing product collation by using such an object fingerprint.

### Second Exemplary Embodiment

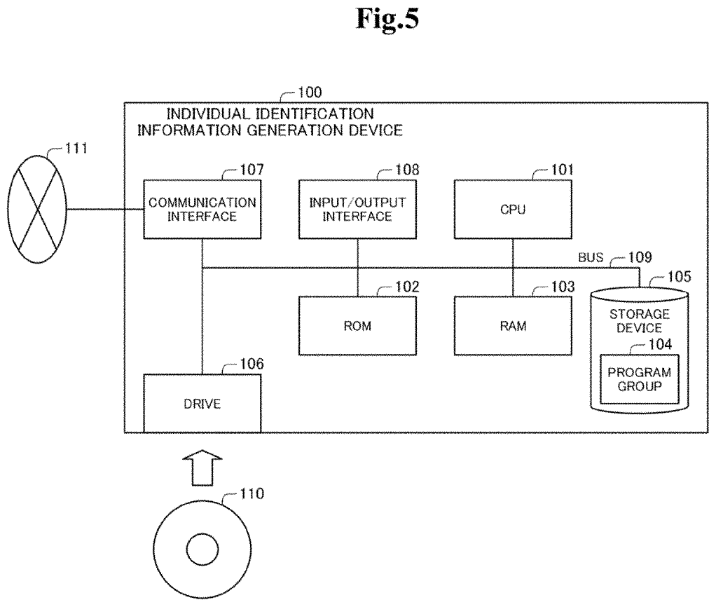

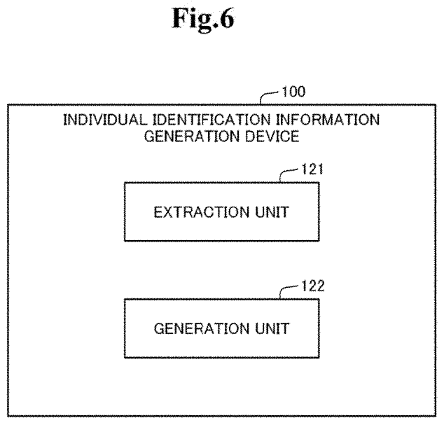

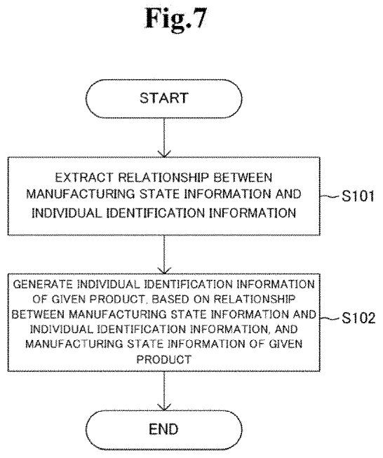

Next, a second exemplary embodiment of the present invention will be described with reference to FIGS. 5 to 7. FIGS. 5 and 6 are block diagrams illustrating a configuration of an individual identification information generation device according to the second exemplary embodiment, and FIG. 7 is a flowchart illustrating an operation of the individual identification information generation device. Note that the present embodiment shows the outlines of the object fingerprint generation device and the processing method by the object fingerprint generation device described in the first exemplary embodiment.

First, a hardware configuration of the individual identification information generation device 100 in the present embodiment will be described with reference to FIG. 5. The individual identification information generation device 100 is configured of a typical information processing device, having a hardware configuration as described below as an example.

Central Processing Unit (CPU) 101 (arithmetic unit)
Read Only Memory (ROM) 102 (storage unit)
Random Access Memory (RAM) 103 (storage unit)
Program group 104 to be downloaded to the RAM 103
Storage device 105 storing therein the program group 104
Drive 106 that performs reading and writing on a storage medium 110 outside the information processing device
Communication interface 107 connecting to a communication network 111 outside the information processing device
Input/output interface 108 for performing input/output of data
Bus 109 connecting the constituent elements

The individual identification information generation device 100 can construct, and can be equipped with, the extraction unit 121 and the generation unit 122 illustrated in FIG. 6 through acquisition and execution of the program group 104 by the CPU 101. Note that the program group 104 is stored in the storage device 105 or the ROM 102 in advance, and is loaded to the RAM 103 by the CPU 101 as needed. Further, the program group 104 may be provided to the CPU 101 via the communication network 111, or may be stored on a storage medium 110 in advance and read out by the drive 106 and supplied to the CPU 101. However, the extraction unit 121 and the generation unit 122 may be constructed by electronic circuits.

Note that FIG. 5 illustrates an example of the hardware configuration of the information processing device that is the individual identification information generation device 100. The hardware configuration of the information processing device is not limited to that described above. For example, the information processing device may be configured of part of the configuration described above, such as without the drive 106.

The individual identification information generation device 100 executes the individual identification information generation method illustrated in the flowchart of FIG. 7, by the functions of the extraction unit 121 and the generation unit 122 constructed by the program as described above.

As illustrated in FIG. 7, the individual identification information generation device 100

extracts, on the basis of product information in which manufacturing state information representing the manufacturing state of a product and individual identification information using a surface pattern of the product acquired from a captured image of the product are associated with each other, a relationship between the manufacturing state information and the individual identification information (step S101), and

generates, on the basis of the relationship between the manufacturing state information and the individual identification information, and the manufacturing state information of a given product, the individual identification information of the given product (step S102).

With the configuration described above, in the present invention, by extracting a feature corresponding to the manufacturing state of a product from the existing individual identification information, even for a given product whose image is not captured, it is possible to newly generate individual identification information by using the feature corresponding to the manufacturing state of the product. Thereby, it is possible to generate individual identification information that reflects the feature of the product whose image is not captured more accurately, which enables individual identification to be performed by using such individual identification information, and enables collation of the product to be performed.

Note that the program described above can be supplied to a computer by being stored in a non-transitory computer-readable medium of any type. Non-transitory computer-readable media include tangible storage media of various types. Examples of non-transitory computer-readable media include a magnetic storage medium (for example, flexible disk, magnetic tape, hard disk drive), a magneto-optical storage medium (for example, magneto-optical disk), a CD-ROM (Read Only Memory). a CD-R, a CD-R/W, a semiconductor memory (for example, mask ROM, PROM (Programmable ROM), and EPROM (Erasable PROM), a flash ROM, and a RAM (Random Access Memory)). Note that the program may be supplied to a computer by being stored in a transitory computer-readable medium of any type. Examples of transitory computer-readable media include an electric signal, an optical signal, and an electromagnetic wave. A transitory computer-readable medium can be supplied to a computer via a wired communication channel such as a wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art.

The present invention is based upon and claims the benefit of priority from Japanese patent application No. 2019-049864, filed on Mar. 18, 2019, the disclosure of which is incorporated herein in its entirety by reference.

### Supplementary Notes

The whole or part of the exemplary embodiments disclosed above can be described as the following supplementary notes. Hereinafter, outlines of the configurations of an individual identification information generation method, an individual identification information generation device, and a program, according to the present invention, will be described. However, the present invention is not limited to the configurations described below.

### Supplementary Note 1

An individual identification information generation method comprising:

on a basis of product information in which manufacturing state information representing a manufacturing state of a product and individual identification information using a surface pattern of the product acquired from a captured image of the product are associated with each other, extracting a relationship between the manufacturing state information and the individual identification information; and

on a basis of the relationship between the manufacturing state information and the individual identification information and of the manufacturing state information of a given product, generating the individual identification information of the given product.

### Supplementary Note 2

The individual identification information generation method according to supplementary note 1, further comprising:

on a basis of the product information, extracting a feature of the individual identification information that is different for each piece of manufacturing state information, as the relationship between the manufacturing state information and the individual identification information; and

on a basis of a feature of the individual identification information corresponding to the manufacturing state information of the given product among the features of the individual identification information, generating the individual identification information of the given product.

### Supplementary Note 3

The individual identification information generation method according to supplementary note 2, further comprising

on a basis of a plurality of features of the individual identification information corresponding to the manufacturing state information of the given product among the features of the individual identification information, generating the individual identification information of the given product.

### Supplementary Note 4

The individual identification information generation method according to supplementary note 2 or 3, wherein

in the manufacturing state information, a plurality of manufacturing state groups for distinguishing products are able to be set, and

the method further comprises:

on a basis of the product information, extracting a feature of the individual identification information that is different for each manufacturing state group, as the relationship between the manufacturing state information and the individual identification information; and

on a basis of a feature of the individual identification information, among the features of the individual identification information, corresponding to one of the manufacturing state groups to which the manufacturing state information of the given product belongs, generating the individual identification information of the given product.

### Supplementary Note 5

The individual identification information generation method according to supplementary note 4, wherein

the manufacturing state information includes a plurality of categories, and a plurality of the manufacturing state groups are able to be set for each of the categories, and

the method further comprises:

on a basis of the product information, extracting, for each of the categories, a feature of the individual identification information that is different for each of the manufacturing state groups set to each of the categories, as the relationship between the manufacturing state information and the individual identification information; and

on a basis of a feature of the individual identification information, among the features of the individual identification information, corresponding to the manufacturing state group of each of the categories to which the manufacturing state information of the given product belongs, generating the individual identification information of the given product.

### Supplementary Note 6

The individual identification information generation method according to supplementary note 5, wherein

the category is at least one of a manufacturing number of a product, a place of manufacture, a manufacturing facility, and date of manufacture.

### Supplementary Note 7

The individual identification information generation method according to any of supplementary notes 1 to 6, further comprising

storing, as the product information, the manufacturing state information of the given product in association with the individual identification information generated for the given product.

### Supplementary Note 8

The individual identification information generation method according to supplementary note 7, further comprising:

generating one or a plurality of pieces of the individual identification information of the given product; and

among the pieces of the individual identification information generated for the given product, deleting a piece of the individual identification information that is stored as the product information.

### Supplementary Note 9

An individual identification information generation device comprising:

an extraction unit that, on a basis of product information in which manufacturing state information representing a manufacturing state of a product and individual identification information using a surface pattern of the product acquired from a captured image of the product are associated with each other, extracts a relationship between the manufacturing state information and the individual identification information; and

a generation unit that, on a basis of the relationship between the manufacturing state information and the individual identification information and of the manufacturing state information of a given product, generates the individual identification information of the given product.

### Supplementary Note 9.1

The individual identification information generation device according to supplementary note 9, wherein

on a basis of the product information, the extraction unit extracts a feature of the individual identification information that is different for each piece of manufacturing state information, as the relationship between the manufacturing state information and the individual identification information, and

the generation unit generates the individual identification information of the given product on a basis of a feature of the individual identification information corresponding to the manufacturing state information of the given product among the features of the individual identification information.

### Supplementary Note 9.2

The individual identification information generation device according to supplementary note 9.1, wherein

the extraction unit generates the individual identification information of the given product on a basis of a plurality of features of the individual identification information corresponding to the manufacturing state information of the given product among the features of the individual identification information.

### Supplementary Note 9.3

The individual identification information generation device according to supplementary note 9.1 or 9.2, wherein

in the manufacturing state information, a plurality of manufacturing state groups for distinguishing products are able to be set,

on a basis of the product information, the extraction unit extracts a feature of the individual identification information that is different for each manufacturing state group, as the relationship between the manufacturing state information and the individual identification information, and

the generation unit generates the individual identification information of the given product on a basis of a feature of the individual identification information, among the features of the individual identification information, corresponding to one of the manufacturing state groups to which the manufacturing state information of the given product belongs.

### Supplementary Note 9.4

The individual identification information generation device according to supplementary note 9.3, wherein

the manufacturing state information includes a plurality of categories, and a plurality of the manufacturing state groups are able to be set for each of the categories,

on a basis of the product information, the extraction unit extracts, for each of the categories, a feature of the individual identification information that is different for each of the manufacturing state groups set to each of the categories, as the relationship between the manufacturing state information and the individual identification information, and

the generation unit generates the individual identification information of the given product on a basis of a feature of the individual identification information, among the features of the individual identification information, corresponding to the manufacturing state group of each of the categories to which the manufacturing state information of the given product belongs.

### Supplementary Note 9.5

The individual identification information generation device according to supplementary note 9.4, wherein

the category is at least one of a manufacturing number of a product, a place of manufacture, a manufacturing facility, and date of manufacture.

### Supplementary Note 9.6

The individual identification information generation device according to any of supplementary notes 9 to 9.5, wherein

the generation unit stores, as the product information, the manufacturing state information of the given product in association with the individual identification information generated for the given product.

### Supplementary Note 9.7

The individual identification information generation device according to supplementary note 9.6, wherein

the generation unit generates one or a plurality of pieces of the individual identification information of the given product, and among the pieces of the individual identification information generated for the given product, deletes a piece of the individual identification information that is stored as the product information.

### Supplementary Note 10

A program for causing an information processing device to realize:

an extraction unit that, on a basis of product information in which manufacturing state information representing a manufacturing state of a product and individual identification information using a surface pattern of the product acquired from a captured image of the product are associated with each other, extracts a relationship between the manufacturing state information and the individual identification information; and

a generation unit that, on a basis of the relationship between the manufacturing state information and the individual identification information and of the manufacturing state information of a given product, generates the individual identification information of the given product.

### REFERENCE SIGNS LIST

10 object fingerprint determination device

11 image reading unit

12 image registration unit

13 image collation unit

14 Image DB

20 object fingerprint generation device

21 image analysis unit

22 image generation unit

100 individual identification information generation device

101 CPU

102 ROM

103 RAM

104 program group

105 storage device

106 drive

107 communication interface

108 input/output interface

109 bus

110 storage medium

111 communication network

121 extraction unit

122 generation unit

What is claimed is:

1. An individual identification information generation method comprising:
on a basis of product information in which manufacturing state information representing a manufacturing state of a product and individual identification information using a surface pattern of the product acquired from a captured image of the product are associated with each other, extracting a relationship between the manufacturing state information and the individual identification information; and
on a basis of the relationship between the manufacturing state information and the individual identification information and of the manufacturing state information of a given product, generating the individual identification information of the given product.

2. The individual identification information generation method according to claim 1, further comprising:
on a basis of the product information, extracting a feature of the individual identification information that is different for each piece of manufacturing state information, as the relationship between the manufacturing state information and the individual identification information; and
on a basis of a feature of the individual identification information corresponding to the manufacturing state information of the given product among the features of the individual identification information, generating the individual identification information of the given product.

3. The individual identification information generation method according to claim 2, further comprising
on a basis of a plurality of features of the individual identification information corresponding to the manufacturing state information of the given product among the features of the individual identification information, generating the individual identification information of the given product.

4. The individual identification information generation method according to claim 2, wherein
in the manufacturing state information, a plurality of manufacturing state groups for distinguishing products are able to be set, and
the method further comprises:
on a basis of the product information, extracting a feature of the individual identification information that is different for each manufacturing state group, as the relationship between the manufacturing state information and the individual identification information; and
on a basis of a feature of the individual identification information, among the features of the individual identification information, corresponding to one of the manufacturing state groups to which the manufacturing state information of the given product belongs, generating the individual identification information of the given product.

5. The individual identification information generation method according to claim 4, wherein
the manufacturing state information includes a plurality of categories, and a plurality of the manufacturing state groups are able to be set for each of the categories, and
the method further comprises:
on a basis of the product information, extracting, for each of the categories, a feature of the individual identification information that is different for each of the manufacturing state groups set to each of the categories, as the relationship between the manufacturing state information and the individual identification information; and
on a basis of a feature of the individual identification information, among the features of the individual identification information, corresponding to the manufacturing state group of each of the categories to which the manufacturing state information of the given product belongs, generating the individual identification information of the given product.

6. The individual identification information generation method according to claim 5, wherein
the category is at least one of a manufacturing number of a product, a place of manufacture, a manufacturing facility, and date of manufacture.

7. The individual identification information generation method according to claim 1 further comprising
storing, as the product information, the manufacturing state information of the given product in association with the individual identification information generated for the given product.

8. The individual identification information generation method according to claim 7, further comprising:
generating one or a plurality of pieces of the individual identification information of the given product; and
among the pieces of the individual identification information generated for the given product, deleting a piece of the individual identification information that is stored as the product information.

9. An individual identification information generation device comprising:
at least one memory configured to store instructions; and
at least one processor configured to execute instructions to:
on a basis of product information in which manufacturing state information representing a manufacturing state of a product and individual identification information using a surface pattern of the product acquired from a captured image of the product are associated with each other, extract a relationship between the manufacturing state information and the individual identification information; and
on a basis of the relationship between the manufacturing state information and the individual identification information and of the manufacturing state information of a given product, generate the individual identification information of the given product.

10. The individual identification information generation device according to claim 9, wherein the at least one processor is configured to execute the instructions to:
on a basis of the product information, extract a feature of the individual identification information that is different for each piece of manufacturing state information, as the relationship between the manufacturing state information and the individual identification information, and
generate the individual identification information of the given product on a basis of a feature of the individual identification information corresponding to the manufacturing state information of the given product among the features of the individual identification information.

11. The individual identification information generation device according to claim 10, wherein the at least one processor is configured to execute the instructions to
generate the individual identification information of the given product on a basis of a plurality of features of the individual identification information corresponding to the manufacturing state information of the given product among the features of the individual identification information.

12. The individual identification information generation device according to claim 10, wherein
in the manufacturing state information, a plurality of manufacturing state groups for distinguishing products are able to be set, and
the at least one processor is configured to execute the instructions to:
on a basis of the product information, extract a feature of the individual identification information that is different for each manufacturing state group, as the relationship between the manufacturing state information and the individual identification information, and
generate the individual identification information of the given product on a basis of a feature of the individual identification information, among the features of the individual identification information, corresponding to one of the manufacturing state groups to which the manufacturing state information of the given product belongs.

13. The individual identification information generation device according to claim 12, wherein
the manufacturing state information includes a plurality of categories, and a plurality of the manufacturing state groups are able to be set for each of the categories, and
the at least one processor is configured to execute the instructions to:
on a basis of the product information, extract, for each of the categories, a feature of the individual identification information that is different for each of the manufacturing state groups set to each of the categories, as the relationship between the manufacturing state information and the individual identification information, and
generate the individual identification information of the given product on a basis of a feature of the individual identification information, among the features of the individual identification information, corresponding to the manufacturing state group of each of the categories to which the manufacturing state information of the given product belongs.

14. The individual identification information generation device according to claim 13, wherein
the category is at least one of a manufacturing number of a product, a place of manufacture, a manufacturing facility, and date of manufacture.

15. The individual identification information generation device according to claim 9, wherein the at least one processor is configured to execute the instructions to
store, as the product information, the manufacturing state information of the given product in association with the individual identification information generated for the given product.

16. The individual identification information generation device according to claim 15, wherein the at least one processor is configured to execute the instructions to
generate one or a plurality of pieces of the individual identification information of the given product, and among the pieces of the individual identification information generated for the given product, delete a piece of the individual identification information that is stored as the product information.

17. A non-transitory computer-readable storage medium in which a program is stored, the program comprising instructions for causing an information processing device to execute processing to:
on a basis of product information in which manufacturing state information representing a manufacturing state of a product and individual identification information using a surface pattern of the product acquired from a captured image of the product are associated with each other, extract a relationship between the manufacturing state information and the individual identification information; and
on a basis of the relationship between the manufacturing state information and the individual identification information and of the manufacturing state information of a given product, generate the individual identification information of the given product.
